(19) United States
(12) Patent Application Publication
(10) Pub. No.: US 2024/0155981 A1
(43) Pub. Date: May 16, 2024

(54) SCALABLE AND MODULAR UNDERGROUND AGRICULTURE SYSTEM

(71) Applicant: GREENFORGES INC., Québec (CA)

(72) Inventors: Philippe LABRIE, Québec (CA); Jamil MADANAT, Québec (CA); Diego Balarezo VINUEZA, Quito (EC); Mehdi KAZEMINIA, Québec (CA); Claude LÉVEILLE, Ontario (CA); Erik J. DURKO, Alpharetta, GA (US); Pierre GAGNÉ, Ontario (CA); Andrew STRIDE, Newfoundland and Labrador (CA)

(21) Appl. No.: 18/552,577

(22) PCT Filed: Apr. 21, 2022
(86) PCT No.: PCT/CA2022/050609

§ 371 Date: Sep. 26, 2023

Related U.S. Application Data
(60) Provisional application No. 63/177,457, filed on Apr. 21, 2021.

(51) Int. Cl. A01G 9/24; A01G 9/18; A01G 18/69

(52) U.S. Cl. CPC A01G 9/247; A01G 9/18; A01G 9/246; A01G 9/249; A01G 18/69

(57) ABSTRACT

An underground agriculture system, comprising: a vertical farming shaft extending downwardly from an aperture on a surface of a body of land to a predetermined depth below the surface of the body of land; mounting apparatuses attached proximate to an edge of the aperture; retractable growing modules attached to the one or more mounting apparatuses and extending downwardly into the void of the vertical farming shaft; a nutrient delivery system comprising a tank and one or more feeding tubes connecting the tank to the one or more retractable growing modules; a lighting module extending downwardly into the void of the vertical farming shaft; a heating, ventilation, and air conditioning (HVAC) system extending into the void of the vertical farming shaft; and an irrigation system comprising a reservoir at a distal end of the vertical farming shaft and a pump operatively connected to the reservoir.

### CROSS-REFERENCE TO RELATED APPLICATIONS

This application claims priority to, and the benefit of International PCT Application No. PCT/CA2022/050609 entitled “SCALABLE AND MODULAR UNDERGROUND AGRICULTURE SYSTEM” filed on Apr. 21, 2022, and claims the benefit of, and priority to, U.S. Provisional Application No. 63/177,457, filed on Apr. 21, 2021, and entitled “SCALABLE AND MODULAR UNDERGROUND AGRICULTURE SYSTEM,” which are incorporated by reference in their entireties.

### TECHNICAL FIELD

The present disclosure relates generally to underground, modular agriculture systems for growing plants, fungi, and/or any particular organism.

### BACKGROUND

The increase of the world population and the daily decrease of natural resources such as farmlands and freshwater poses a significant challenge to the food supply chain and its quality. In Canada, today, there are 30% fewer farms compared to the year 1961, and the average age of the farmers is 55 years old. In addition, climate change and global warming lead to natural disasters, adding uncertainty to conventional agriculture. Controlled Environment Agriculture and Agri-Tech related technologies may play essential roles in offering sustainable yet reliable and scalable solutions.

Several types of greenhouses have been designed and are currently handling a significant portion of the human food supply chain. Although those technologies offer valuable solutions and save a considerable amount of energy and water when producing the same amount of crops compared to conventional agriculture, they are still restricted by weather constraints and real estate capacity. Their construction is very time-consuming and expensive, and they need to occupy a considerable amount of land. In urban areas, this issue causes a flaw in the scalability and competitiveness of controlled environment agriculture applications. Additionally, controlled environment agriculture applications located in areas with very hot and cold temperature fluctuations use a large amount of energy to maintain the temperature at a suitable range for the production of most plants.

Therefore, there is a long-felt but unresolved need for systems, methods, or apparatuses that reduce the real-estate capacity of agriculture environments while maintaining a low climate impact and high-quality production of produce.

### BRIEF SUMMARY OF THE DISCLOSURE

Briefly described, and according to one embodiment, aspects of the present disclosure generally relate to systems, methods, and apparatuses for controlled environment agriculture (CEA) and, more specifically, an underground agricultural system for the production of biomass using different modular configurations.

In some embodiments, an agriculture environment includes a sealed structure that offers protection for at least one or more underground agriculture systems. In particular embodiments, the underground agriculture system includes a deep hole or void (also sometimes referred to herein as “vertical farming shaft” or “farming shaft”) under a surface of a body of land with various components that function to facilitate growing plants, fungi, and/or any other type of growing organism. In various embodiments, underground agriculture systems include movable growing modules, mounting apparatuses, utility modules, nutrient delivery systems, and other particular systems used to grow plants in the underground environment.

Growing modules may be loaded with C3 plants, C4 plants, CAM plants, Fungi, and/or any other particular type of growing organism. In various embodiments, the growing modules are placed into the vertical farming shafts by attaching the modules to a mounting apparatus. In some embodiments, the vertical farming shaft is substantially cylindrical to facilitate placing more than one growing module into the agriculture environment. In at least one embodiment, the cylindrical construction of the vertical farming shaft facilitates having the growing modules face the middle of the agriculture environment.

The underground agriculture systems may include a utility module for delivering photoactive radiation to the biomass growing underground. For example, lighting modules may be outfitted to a utility module with LED lights, mirrors, Fresnel lenses, and fiber optics. In various embodiments, the utility module is placed at the center of the underground agriculture system to project light, cooled air, dehumidified air, and/or any other particular substance necessary to maintain plant growth. In at least one embodiment, to control airflow, temperature, humidity, and other variables in the underground agriculture system, the utility modules are outfitted with sensors, cameras, fans, and/or other pieces of hardware used to affect the particular environment. In some embodiments, the utility module and growing modules are removable from the vertical farming shaft for servicing from the surface.

In particular embodiments, the system may be constructed under existing farmland, parking lots, and/or buildings in urban environments as well as in a broad range of natural environments. Additionally, a broad range of construction equipment, from small drilling rigs to large boring equipment, can be used to build the underground agriculture system.

In at least one embodiment, the underground soil surrounding the vertical farming shaft provides a stable environment and a natural insulation from particular elements. In certain embodiments, the system offers significant savings in space, energy, materials, and water when compared to surface-based sunless agricultural operations.

According to a first aspect, an underground agriculture system, comprising: A) a vertical farming shaft comprising a void extending downwardly from an aperture on a surface of a body of land to a predetermined depth below the surface of the body of land; B) one or more mounting apparatuses attached proximate to an edge of the aperture; C) one or more retractable growing modules attached to the one or more mounting apparatuses and extending downwardly into the void of the vertical farming shaft; D) a nutrient delivery system comprising a tank and one or more feeding tubes connecting the tank to the one or more retractable growing modules; E) a lighting module extending downwardly into the void of the vertical farming shaft; F) a heating, ventilation, and air conditioning (HVAC) system extending into the void of the vertical farming shaft; and G) an irrigation system comprising a reservoir at a distal end of the vertical farming shaft and a pump operatively connected to the reservoir.

According to a further aspect, the underground agriculture system of the first aspect or any other aspect, further comprising a retractable lid for covering the aperture on the surface of the body of land.

According to a further aspect, the underground agriculture system of the first aspect or any other aspect, wherein the pump is configured to pump water and plant byproduct from the reservoir at the distal end of the vertical farming shaft to a location outside of the vertical farming shaft.

According to a further aspect, the underground agriculture system of the first aspect or any other aspect, wherein the one or more retractable growing modules include a plurality of plant cradles for holding a plurality of plants, fungi, or a combination thereof.

According to a further aspect, the underground agriculture system of the first aspect or any other aspect, further including an extraction system, comprising: A) a frame extending over the aperture on the surface of the body of land; B) a hoist system including an attachment means that is operatively connected to at least one of the one or more retractable growing modules and is configured to raise the growing modules out of the vertical farming shaft.

According to a further aspect, the underground agriculture system of the first aspect or any other aspect, wherein the vertical farming shaft has a cross-section comprising a circular shape, a rectangular shape, a square shape, a trapezoidal shape, an oval shape, an obround shape, or a polygon shape.

According to a further aspect, the underground agriculture system of the first aspect or any other aspect, wherein the circular shape of the vertical farming shaft comprises a diameter in the range of 1-60 feet.

According to a further aspect, the underground agriculture system of the first aspect or any other aspect, wherein the nutrient delivery system includes a nutrient pump operatively connected to the tank and the one or more feeding tubes and is configured to move nutrients from the tank to the one or more retractable growing modules.

According to a further aspect, the underground agriculture system of the first aspect or any other aspect, wherein nutrients mixed into the tank of the nutrient delivery system comprise nitrogen, phosphorus, potassium, calcium, water, or a combination thereof.

According to a further aspect, the underground agriculture system of the first aspect or any other aspect, further comprising a casing mated with a circumferential surface of the vertical farming shaft.

According to a further aspect, the underground agriculture system of the first aspect or any other aspect, wherein the casing is made from, steel, stainless-steel, aluminum, polypropylene, a non-corrosive environmentally-stable material, or a combination thereof.

According to a further aspect, the underground agriculture system of the first aspect or any other aspect, wherein the one or more mounting apparatuses each further comprise: A) a holster suspended from one or more cables at a position within the vertical farming shaft; and B) a hooking mechanism.

According to a further aspect, the underground agriculture system of the first aspect or any other aspect, wherein the holster receives a lowermost end of the one or more retractable growing modules and the hooking mechanism receives an extraction cable connected to the one or more retractable growing modules.

According to a second aspect, an underground agriculture system, comprising: A) a cylindrical farming shaft defining a cylindrical void extending downwardly from a surface of a body of land to a predetermined depth below the surface of the body of land; B) a casing encircling a circumference of the cylindrical farming shaft and configured to segregate the cylindrical void from the body of land; C) a plurality of mounting apparatuses mounted externally to the cylindrical farming shaft and extending at least partially into the cylindrical void; D) a plurality of retractable growing modules operatively connected to the plurality of mounting apparatuses and extending downwardly into the cylindrical void of the cylindrical farming shaft, wherein each retractable growing module is attached to a respective mounting apparatus and is configured to be lifted from the cylindrical void by cables pulled via the respective mounting apparatus; E) a nutrient delivery system comprising a tank and a plurality of feeding tubes connecting the tank to the plurality of retractable growing modules; F) a utility module extending downwardly into the cylindrical void coaxially with the cylindrical farming shaft, wherein the utility module comprises: 1) a lighting module configured to provide light radially outwardly from the utility module to the plurality of retractable growing modules; and 2) an air delivery system configured to provide heated or cooled air into the cylindrical void of the cylindrical farming shaft; and G) an irrigation system comprising a reservoir at a lowermost end of the cylindrical farming shaft and a pump operatively connected to the reservoir.

According to a further aspect, the underground agriculture system of the second aspect or any other aspect, wherein the pump is configured to pump water and plant byproduct from the reservoir at the lowermost end of the cylindrical farming shaft to a location outside of the cylindrical farming shaft.

According to a further aspect, the underground agriculture system of the second aspect or any other aspect, wherein the plurality of retractable growing modules each include a plurality of plant cradles for holding a plurality of plants, fungi, or a combination thereof.

According to a further aspect, the underground agriculture system of the second aspect or any other aspect, wherein the nutrient delivery system includes a nutrient pump operatively connected to the tank and the plurality of feeding tubes and is configured to move nutrients from the tank to the plurality of retractable growing modules.

According to a further aspect, the underground agriculture system of the second aspect or any other aspect, further comprising a control unit that is configured to control the plurality of mounting apparatuses, the nutrient delivery system, the utility module, and the irrigation system.

According to a further aspect, the underground agriculture system of the second aspect or any other aspect, wherein the lighting module is configured to produce light with a wavelength in the range of 100-280 nanometers to sanitize interior surfaces of the cylindrical farming shaft.

According to a further aspect, the underground agriculture system of the second aspect or any other aspect, wherein the air delivery system is configured to inject a particular amount of carbon-dioxide, nitrogen, oxygen, or a combination thereof into the cylindrical farming shaft.

According to a further aspect, the underground agriculture system of the second aspect or any other aspect, wherein the utility module further comprises turbulence fans, motorized drivers, and electronic components configured to operate the lighting module, air delivery system, turbulence fans, and motorized drivers. These and other aspects, features, and benefits of the claimed invention(s) will become apparent from the following detailed written description of the preferred embodiments and aspects taken in conjunction with the following drawings, although variations and modifications thereto may be effected without departing from the spirit and scope of the novel concepts of the disclosure.

### BRIEF DESCRIPTION OF THE DRAWINGS

The accompanying drawings illustrate one or more embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1 illustrates a perspective view of an agriculture environment, according to one embodiment of the present disclosure;

FIG. 2 illustrates a perspective view of an underground agriculture system, according to one embodiment of the present disclosure;

FIG. 3 illustrates a perspective view of an underground agriculture system, according to one embodiment of the present disclosure;

FIG. 4 illustrates an enhanced perspective view of an underground agriculture system, according to one embodiment of the present disclosure;

FIG. 5 illustrates an enhanced perspective view of an aperture of an underground agriculture system, according to one embodiment of the present disclosure;

FIG. 6 illustrates a perspective view of a utility module, according to one embodiment of the present disclosure;

FIG. 7 illustrates a perspective view of a first mounting apparatus, according to one embodiment of the present disclosure;

FIG. 8A illustrates a perspective view of a second mounting apparatus, according to one embodiment of the present disclosure; and

FIG. 8B illustrates a perspective view of a third mounting apparatus, according to on embodiment of the present disclosure.

### DETAILED DESCRIPTION

Whether or not a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. However, the capitalization or lack thereof within the remainder of this document is not intended to be necessarily limiting unless the context clearly indicates that such limitation is intended.

### Overview

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims.

Aspects of the present disclosure generally relate to systems and methods for growing plants, fungi, and other particular organisms in underground agriculture systems. In some embodiments, the underground agriculture systems are formed by drilling or excavating cylindrical, rectangular, trapezoidal, square, circular, and/or any particular shape configuration into a surface of a body of land. In various embodiments, an aperture is produced at the surface of the body of land, indicating the opening of the underground agriculture system. In one or more embodiments, the underground agriculture systems include a void that is created after removing a particular amount of land during the drilling or excavating process. The void may be lined with a casing to form a vertical farming shaft. In at least one embodiment, the casing is formed from, steel, stainless steel, aluminum, polypropylene, a non-corrosive environmentally-stable material, or a combination thereof. The components of the underground agriculture system may be installed into the vertical farming shaft. For example, at least one or more mounting apparatuses may be mounted to the edge (or around or proximate to the edge) of the vertical farming shaft, a pump for the irrigation system may be placed at the base or lowermost portion of the vertical farming shaft, a utility module may be placed at the center of the vertical farming shaft, and growing modules may be placed into the vertical farming shaft by attaching to the mounting apparatuses.

The growing modules may extend through the vertical farming shaft and face inwards towards the center. For example, the growing modules may include plant apertures that may receive plants, fungi, or other organisms for growth. Continuing this example, the growing modules may mount onto the mounting apparatuses and face the center of the vertical farming shaft. In some embodiments, extending down into the vertical farming shaft (e.g., at the center of the vertical farming shaft), the underground agriculture system may include the utility module. The utility module may include a lighting system, fan system, camera system, heating, ventilation, and air conditioning (HVAC) system, camera system, and any other system used to maintain the functionality of the underground agriculture systems.

In particular embodiments, the underground agriculture systems include a nutrient delivery system. The nutrient delivery system may facilitate distributing nutrients, water, and any other particular substance to the growing modules necessary for the growth of a particular plant, fungi, or living organism. For example, the nutrient delivery system may include a nutrient tank for storing nutrients diluted into water (e.g., magnesium, potassium, calcium, etc.). Continuing this example, a nutrient pump may facilitate moving the nutrient diluted water from the nutrient tank into the growing modules through at least one or more feeding tubes. The underground agriculture system may include an irrigation system at the base of the vertical farming shaft used to collect plant byproducts and/or excess water produced by the nutrient delivery system. In at least one embodiment, the irrigation system includes a reservoir used to collect water and other organism byproducts and a pump used to extract the substances from the reservoir.

After a plant's particular growth cycle in the underground agriculture system, the growing module in which the plant resides may be removed for harvesting, examination, and/or analysis. In some embodiments, the underground agriculture system includes an extraction system placed at the surface of the body of land over the aperture of the underground agriculture system. The extraction system may include a frame extending over the aperture of the vertical farming shaft, a hoist mechanism used to extract the growing modules from the vertical farming shaft, and an externally facing rack for mounting the extracted growing modules.

In at least one embodiment, the underground agriculture systems can be concentrated and controlled in an agriculture environment. In particular embodiments, the agriculture environment is a structure built above ground to cover at least one or more underground agriculture systems. In various embodiments, the agriculture environment includes all necessary components for facilitating plant, fungi, and/or organism growth within at least one or more underground agriculture systems. For example, the agriculture environment may include a roof and walls to preclude the underground agriculture systems from interacting with an uncontrolled environment (e.g., open-air environments). Continuing this example, the agriculture environment may include, but is not limited to, a central control unit, natural lighting systems, weather control systems, nutrient tank storages, underground agriculture systems, and quality testing areas.

### Exemplary Embodiments

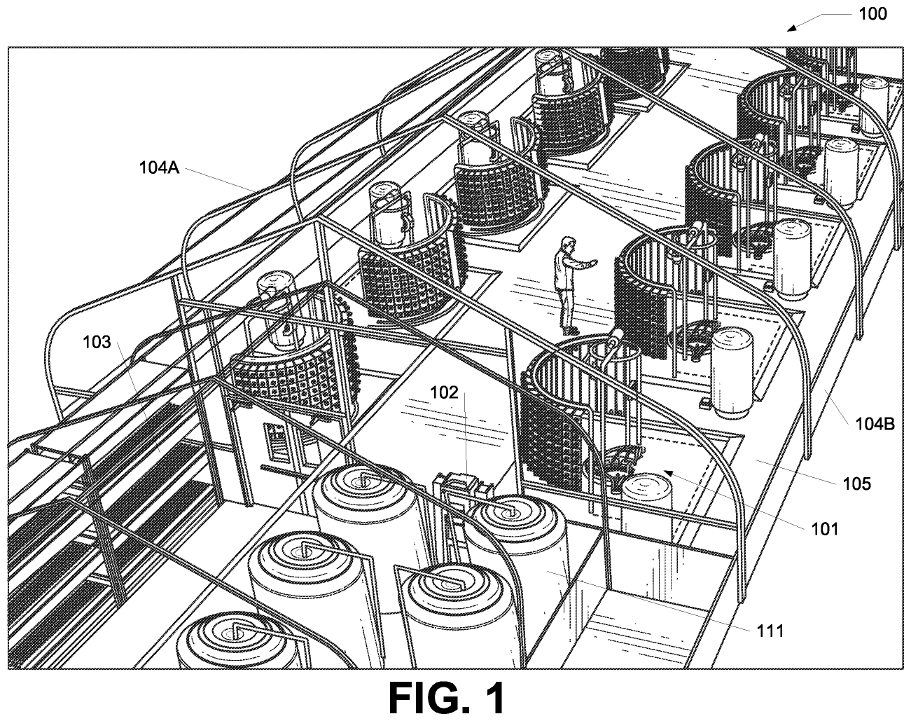

Referring now to the figures, for the purposes of example and explanation of the fundamental processes and components of the disclosed systems and processes, reference is made to FIG. 1, which illustrates an exemplary agriculture environment 100, according to one or more embodiments. As will be understood and appreciated, the agriculture environment 100 shown in FIG. 1 represents merely one approach or embodiment of the present system, and other aspects are used according to various embodiments of the present system.

In some embodiments, the agriculture environment 100 may facilitate enclosing and isolating at least one or more underground agriculture systems 101 from outdoor environments. In at least one embodiment, the agriculture environment 100 may include all systems and controlling mechanisms necessary for growing plants, fungi, and/or any particular organism in the underground agriculture systems 101. The agriculture environment 100 may provide an alternative method for growing plants in a sustainable fashion while maintaining a reduced area of production.

In various embodiments, the agriculture environment 100 may be constructed on any particular body of land. For example, the agriculture environment 100 may be constructed in an abandoned factory, a portion of farmland, or in the basement of a commercial office building. The agriculture environment 100 may include a building structure to cover the environment from natural elements. In particular embodiments, the building structure of the agriculture environment 100 is newly constructed or is a repurposed building. For example, the agriculture environment 100 may be constructed within a preexisting abandoned factory. In some embodiments, the agriculture environment 100 may include a roof frame 104A covered by a roof and a series of walls 104B. The walls 104B may extend upwards towards the roof frame and connect with a roof (not pictured). The walls 104B and the roof may connect to create a sealed agriculture environment 100. The walls 104B and the roof may include windows and other natural lighting systems used to divert natural lighting into the agriculture environment 100. For example, the walls 104B may include windows, minors, reflectors, or focal systems, to divert light into fiber optic cables or into the general space of the agriculture environment 100. Continuing this example, a fiber optic cable carrying natural light may divert the light into at least one or more underground agriculture systems 101 to reduce the reliance on artificially produced light.

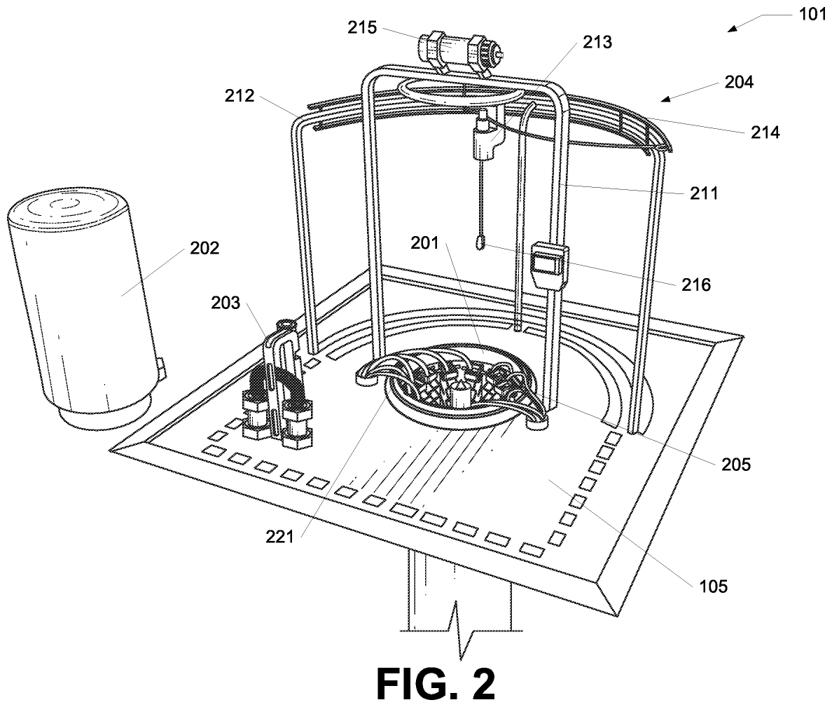

The agriculture environment 100 may include at least one or more underground agriculture systems 101. In particular embodiments, the underground agriculture systems 101 facilitate farming various plants, fungi, and/or organisms in a climate-controlled environment underground. In at least one embodiment, the underground agriculture systems 101 are a series of voids or holes produced in a surface 105 of a body of land. In certain embodiments, the underground agriculture systems 101 are created by drilling or excavating a void into the surface 105 of the body of land. The voids may include any particular shape, such as a cylindrical configuration, a rectangular configuration, a trapezoidal configuration, a triangular configuration, a square configuration, or any other shape configuration. For example, in a cylindrical configuration, the void and/or hole can include a diameter of at least 1 foot, 1-60 feet, 1-10 feet, 10-20 feet, 20-30 feet, 30-40 feet, 40-50 feet, 50-60 feet, or less than 60 feet. Continuing this example, the depth of the void may be at least 1 foot, 1-100 feet, 1-50 feet, 50-100 feet, or less than 100 feet. In another example, a rectangular configuration may have a width of 1 foot, 1-60 feet, 1-10 feet, 10-20 feet, 20-30 feet, 30-40 feet, 40-50 feet, 50-60 feet, or less than 60 feet. Continuing this example, the rectangular configuration may have a length of 1 foot, 1-60 feet, 1-10 feet, 10-20 feet, 20-30 feet, 30-40 feet, 40-50 feet, 50-60 feet, or less than 60 feet. Continuing this example, the depth of the rectangular configuration may be at least 1 foot, 1-100 feet, 1-50 feet, 50-100 feet, or less than 100 feet. In at least one or more embodiments, the drill or excavator used may produce an aperture 201 (see FIG. 2). For example, on removing land from the location of the underground agriculture system 101, the drill produces the aperture 201 and the void of the underground agriculture system 101. The underground agriculture system 101 may provide a climate-controlled environment while reducing the land necessary for farming particular organisms. In at least one embodiment, the surrounding land beneath the surface 105 provides an insulating effect for the underground agriculture systems 101. The underground agriculture systems 100 may be produced with any conventional drilling technique.

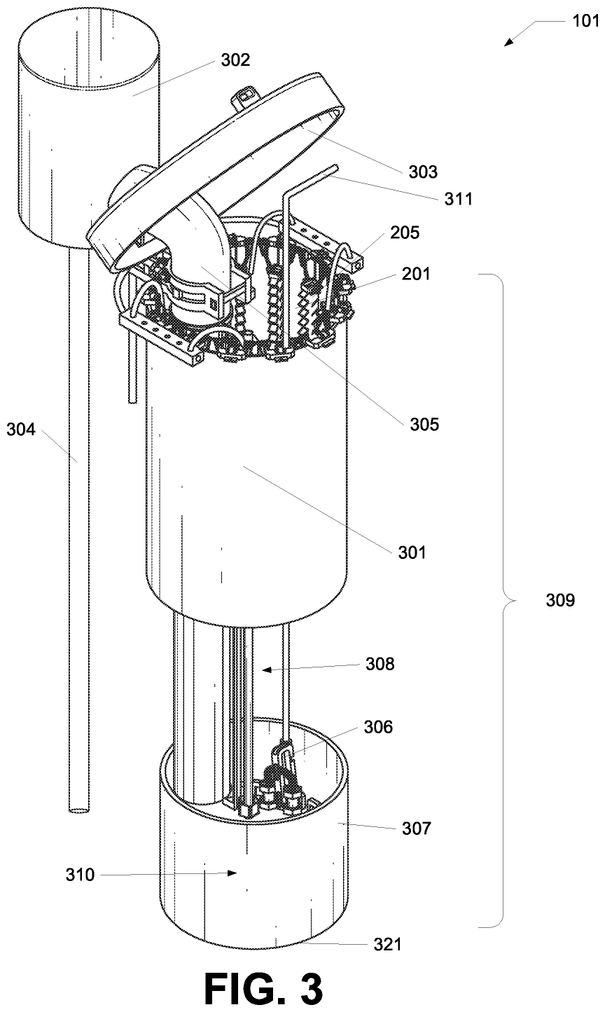

The agriculture environment 100 may include a central control unit 102. The central control unit 102 may control all processes performed in the agriculture environment 100. For example, the central control unit 102 may monitor humidity levels in each of the underground agriculture systems 101 and activate a heating, ventilation, and air conditioning system 302 (HVAC) to reduce the humidity levels in particular agriculture environments 101 (see FIG. 3). In another example, the central control unit 102 may decrease the general temperature of the agriculture environment 100 by activating a central cooling system (not pictured) after measuring a temperature greater than a particular threshold. The central control unit 102 may manage the computational requirements of the underground agriculture systems 101. The central control unit 102 may use machine learning techniques and/or statistical analysis on data gathered within the agriculture environment 100 to perform particular actions. For example, the central control unit 102 can create a model for predictively watering plants in the underground agriculture system 101. In at least some embodiments, the central control unit 102 may monitor the underground agriculture systems 101 individually, in groups, or as an entire component of the agriculture environment 100. For example, if various growing modules 205 (see FIG. 2) of a first underground agriculture system 101 require water and the growing modules 205 of a second underground agriculture system 101 do not require watering, the central control unit 102 may selectively water the necessary underground agriculture systems 101. In further embodiments, each individual underground agriculture system 101 may have its own individual control unit (not shown) that is used to control the processes, modules, and systems of the respective agriculture system.

The agriculture environment 100 may include a plant management area 103. In various embodiments, the plant management area 103 provides an area for analyzing plant growth, conducting experiments, and preparing growing modules 205. For example, when a series of growing modules 205 have plants that have reached max growth potential, the growing modules 205 are removed from the underground agricultural systems 101 and stored in the plant management area 103 for extraction.

The agriculture environment 100 may include storage tanks 111. In at least one embodiment, the storage tanks 111 store nutrients, natural pesticides, disinfectant solutions, water, gases (e.g., carbon dioxide, nitrogen, oxygen, etc.), and/or any other substance used within the agriculture environment 100. The storage tanks 111 may be connected to the underground agriculture systems 101 for distributing particular substances. For example, a nutrient tank 202 (see FIG. 2) may receive nutrients from the storage tank 111 when the nutrient tank 202 is low on nutrients. In another example, the central control unit 102 may release natural pesticides from the storage tank 111 into the underground agriculture system on the detection of pests and/or other adverse organisms.

Referring now to FIG. 2, illustrated is an exemplary underground agriculture system 101, according to one embodiment of the present disclosure. In various embodiments, the underground agriculture system 101 includes components located both above and below the surface 105 of the body of land. FIG. 2, however, shows particularly the system components located above the land's surface. In particular embodiments, the underground agriculture system 101 includes an aperture 201, a nutrient tank 202, a nutrient pump 203, an extraction system 204, and growing modules 205.

In some embodiments, the aperture 201 demarcates the entry point of the underground agriculture system 101. In at least one embodiment, the aperture 201 is produced after a drill or other digging or excavation means removes an amount of land or Earth from beneath the surface 105. In some embodiments, the aperture 201 has a substantially circular configuration. For example, the aperture 201 may have a diameter of at least 1 foot, 1-60 feet, 1-10 feet, 10-20 feet, 20-30 feet, 30-40 feet, 40-50 feet, 50-60 feet, or less than 60 feet. In at least one embodiment, the diameter of the aperture 201 may extend throughout a vertical void to define a cylindrical configuration. In some embodiments, a cylindrical configuration is more readily available given the ubiquitous access to circular drilling techniques. Any particular drilling apparatus may be used to formulate the void of the underground agriculture system 101. For example, an oil drilling rig can be repurposed for drilling underground agriculture systems 101. In particular embodiments, the diameter throughout the void decreases, increases, or stays constant as compared to the diameter of the aperture 201. For example, the distal end of the void may have a diameter smaller than the diameter of the aperture 201, creating a substantially conical shape. In at least one embodiment, the growing modules 205, along with other components of the underground agriculture system 101, are deposited into the underground agriculture system 101 through the aperture 101.

In at least one or more embodiments, the nutrient tank 202 may receive and distribute nutrients to the growing modules 205. In at least one embodiment, the nutrient tank 202 is connected to the growing modules 205 through at least one or more feeding tubes 221. The at least one or more feeding tubes may receive nutrients from the nutrient tank 202 to feed the connected growing modules 205. Nutrients may include, but are not limited to, nitrogen, phosphorus, potassium, calcium, water, or a combination thereof. The nutrient tank 202 may take advantage of gravity to move nutrients from the nutrient tank 202 to the growing modules 205 through the feeding tubes 221. In some embodiments, a nutrient pump 203 facilitates moving the nutrients from the nutrient tank 202 to the growing modules 205. For example, the nutrient pump 203 may pull nutrients from the nutrient tank 202 and move the nutrients throughout the feeding tubes 221 into the growing modules 205. In some embodiments, the feeding tubes 221 are connected to the top component of the growing modules 205 such that the nutrients move throughout the entire growing modules 205 with the use of gravity. In at least one embodiment, the central control unit 102 determines when and how much nutrients should be added to a growing module 205. For example, the central control unit 102 may activate the nutrient pump 203 to pull nutrients from the nutrient tank 202 at a particular rate. Continuing this example, the nutrient pump 203 may move the nutrients from the nutrient tank 202 to the growing modules 205 at the specified rate by the central control unit 102. In some embodiments, adjusting the rate of flow of nutrients can facilitate even distribution of content thought the entire growing module 205. In many embodiments, the nutrient tank 202 may be a three-hundred thirty (330) gallon nutrient tank 202, but may be larger or smaller depending on the depth of the underground agriculture system 101 or the amount of growing modules 205 serviced. In at least one embodiment, the nutrient tank 202 may include one or more pH sensors, one or more temperature sensors, and one or more electrical conductivity sensors, which are connected to the central control unit for monitoring and analysis.

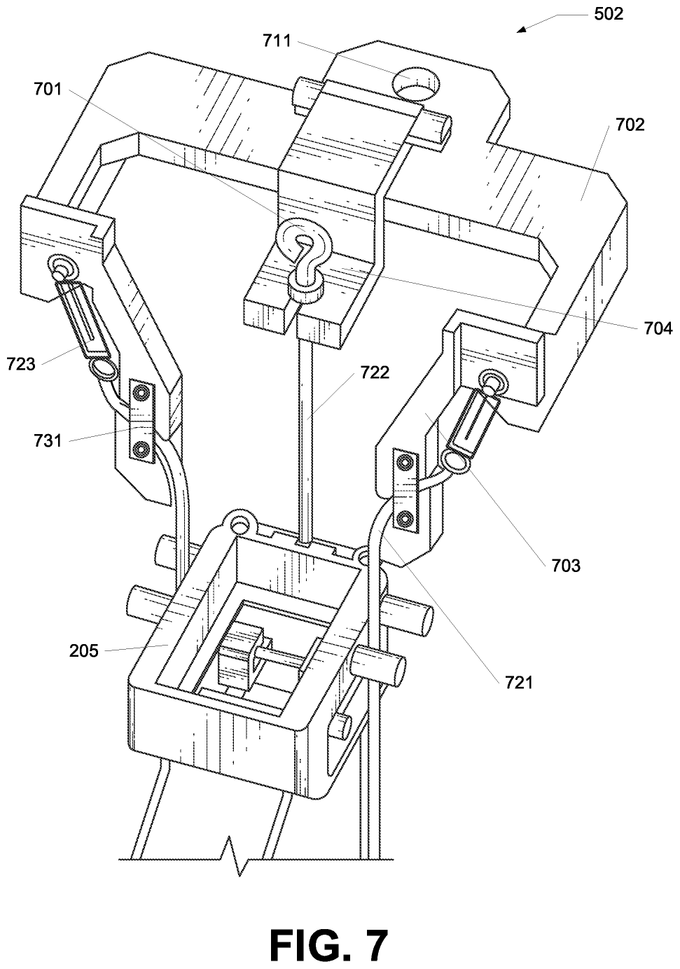

The extraction system 204 may operate above the aperture 201 and can extract components from the underground agriculture system 101. The extraction system can include a frame 211, an external frame 212, a hoist mechanism 213, a motor 215, an external rack 214, and an extraction hook 216. In some embodiments, the hoist mechanism 213 is attached to the frame 211. In particular embodiments, the motor 215 is connected to the hoist mechanism 213 to facilitate removing the growing modules 205. In at least one embodiment, the hoist mechanism 213 connects to the growing modules 205 for extraction. For example, the extraction hook 216 of the hoist mechanism 213 may be connected to a growing module hook 701 (see FIG. 7). Continuing this example, the motor 215 can be activated and begins to pull up the growing module 205 out of the underground agriculture system 101. Continuing this example, once a sufficient amount of the growing module 205 has been removed, the growing module 205 can be transferred to the external rack 214 for further inspection and/or harvesting. In some embodiments, the hoist mechanism 213 can function independently from the motor 215. For example, the hoist mechanism may use various pulleys to allow a user to extract the growing modules 205 without external input.

In various embodiments, the external frame 212 and the external rack 214 may demarcate the locations of various underground agriculture systems 101 in the agriculture environment 100. For example, the external frame 212 may be placed near the aperture 201 to indicate the location of the underground agriculture system 101. In particular embodiments, the external frame 212 may act as a visual safety indicator to anyone walking near the underground agriculture system 101. In at least one embodiment, the external frame 212 and/or external rack 214 can have a semicircular configuration, a rectangular configuration around the entire underground agriculture system 101, a circular configuration around the entire underground agriculture system 101, and/or an elliptical configuration around the entire underground agriculture system 101. In at least one embodiment, the external rack 212 can make use of space efficiently by providing an area to hang, inspect, harvest, and/or interact with the extracted growing modules 205 near the underground agriculture system 101. In particular embodiments, the external rack 214 and external frame 212 can maximize the growth potential of the agriculture environment 100.

Referring now to FIG. 3, illustrated is a perspective view of the underground agriculture system 101, according to one embodiment of the present disclosure. In particular embodiments, the underground agriculture system 101 can include a casing 301, an HVAC system 302, a lid 303, a geothermal void 304, an HVAC duct 305, a pump 306, a reservoir 307, a utility module 308, and a vertical farming shaft 309. The top of the casing 301, nearest to the aperture 201, may be flush with the surface 105 (not pictured). The components below the aperture 201 (e.g., casing 301, growing modules 205, utility module 308, pump 306, reservoir 307, etc.) are below the surface 105 of a body of land. The components above the aperture 201 (e.g., HVAC system 302, lid 303, portions of the HVAC duct 305, etc.) are above the surface 105 of the body of land.

The casing 301 may be installed around the circumference or perimeter of the void of the underground agriculture system 101. In some embodiments, the casing 301 can seal the underground agriculture system 101 from exterior environmental interactions. In some embodiments, the casing 301 is made from, steel, stainless steel, aluminum, polypropylene, a non-corrosive environmentally-stable material, or a combination thereof. In various embodiments, steel may be an accessible material, light weight, relatively inexpensive, and structurally capable of handling the stresses of the underground agriculture system 101. For example, the casing 301 made from steel can be sufficiently malleable to fit in the void of the underground agriculture system 101 and provide structural integrity to withstand the forces produced by the surrounding land. The casing 301 may be coated with anti-rust materials and substances, food-grade protective materials and substances, reflective coatings to increase plant light absorption and system efficiencies, or a combination thereof. In some embodiments, the casing 301 facilitates creating a barrier between the underground agriculture system 101 and the exterior land. For example, the casing 301 can reduce runoff and potential contamination produced by byproducts of the underground agriculture system 101. Thus, although not shown, in practice all of the casing 301 would be underground, such that the exterior surface of the casing 301 would abut against surrounding ground or Earth. In various embodiments, the casing 301 can form an insulating barrier for the underground agriculture system 101. In at least one or more embodiments, the casing 301 can be made of an environmentally friendly biodegradable material meant to degrade after a particular amount of time. For example, if the underground agriculture system 101 is temporary, the casing 301 can be formulated with biodegradable material meant to degrade after the life expectancy of the underground agriculture system 101. In some embodiments, the casing 301 extends to the reservoir 307, forming a continuous closed surface within the agriculture environment 101. Although FIG. 3 illustrates a gap in between the casing 301 and the reservoir 307, this distinction is made for illustrative purposes to see the interior of the system and is not intended to limit the embodiments of the underground agriculture system 101.

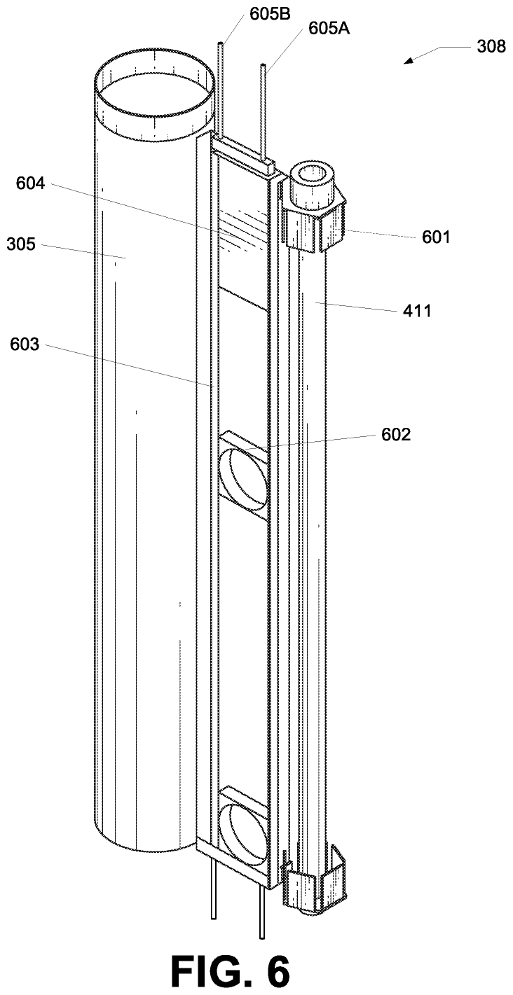

In some embodiments, the utility module 308 manages all components located in the center of the underground agriculture system 101. The utility module 308 can extend from the aperture 201 to a base 321 of the underground agriculture system 101. The utility module 308, along with its other components, will be discussed in further detail herein (see FIG. 6).

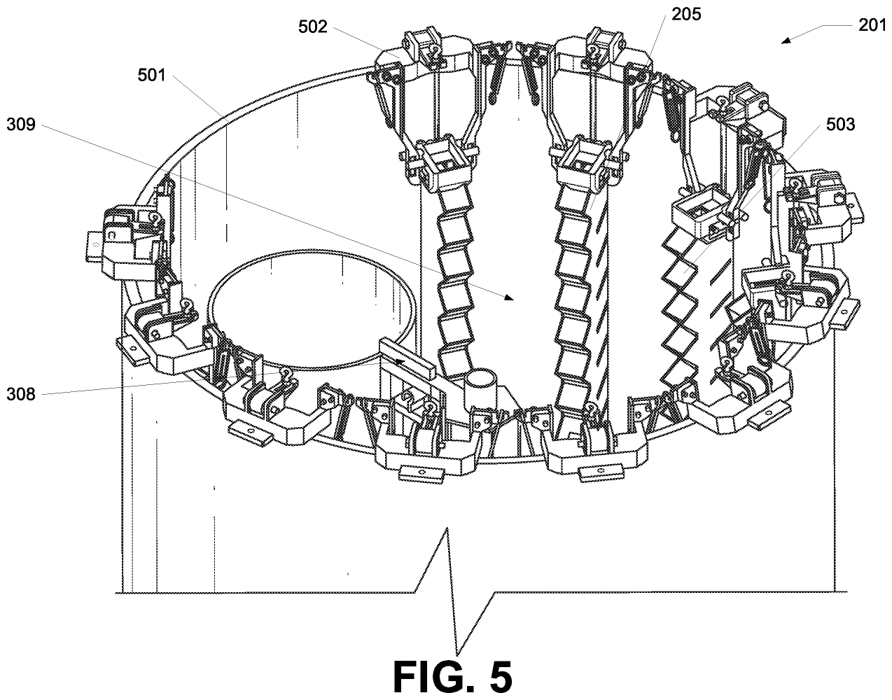

In at least one embodiment the growing modules 205 can face towards the utility module 308. For example, the growing modules 205 can be placed on the inner surface of the vertical farming shaft 309, facing towards the center. Continuing this example, the utility module 308 is placed at the center of the vertical farming shaft 309. In another example, the growing modules 205 may be placed in the center and face outwards towards the inner surface of the vertical farming shaft 309. Continuing this example, the growing cradles 503 (see FIG. 5) may face the inner surface of the vertical farming shaft 309. Continuing this example, the components of the utility module 308 may integrate into and/or onto the inner surface of the vertical farming shaft 309. In various embodiments, the growing modules 205 can be horizontally stored in the underground agriculture system 101. For example, the vertical farming shaft may include a rectangular configuration. Continuing this example, rectangular growing modules may store plants, fungi, or any particular growing organism facing towards the aperture of the rectangular vertical farming shaft.

In some embodiments, the utility module 308 includes an HVAC system 302. The HVAC system 302 may manage the temperature, humidity, air circulation, and gaseous nutrient concentration within the underground agriculture system 101. In some embodiments, the HVAC system 302 uses conventional systems to regulate temperature and other conditions. In particular embodiments, the HVAC system 302 uses the geothermal void 304 to extract regulated thermal energy from the surrounding land and transfer it to the underground agriculture system 101. The HVAC system 302 can measure the current gaseous nutrients available in the underground agriculture system 101 and can increase or maintain its concentration accordingly. For example, the HVAC system 302 can include CO2 sensors that measure the CO2 concentration of the underground agriculture system 101. Continuing this example, if the HVAC system 302 measures a CO2 deficiency, the HVAC system 302 can extract CO2 from the storage tanks 111 and increase the CO2 concentration in the underground agriculture system. In another example, the HVAC system 302 can measure the humidity concentration in the underground agriculture system 101. Continuing this example, if the HVAC system 302 measures an excessive humidity concentration, the HVAC system 302 can extract moisture from the air using the air conditioning system. The HVAC system 302 can include the HVAC duct 305 that extends from the HVAC system 302 to the base 321 of the underground agriculture system 101.

Embodiments of the lid 303 may facilitate closing the aperture 201 of the underground agriculture system 101. In various embodiments, the lid 303 is closed to maintain climate-controlled temperatures, reduce pest infestations, reduce natural light intake, and/or control any other particular variable. In some embodiments, the lid 303 can be automatically closed through the central control panel 102. In various embodiments, the lid 303 is closed by a user of the underground agriculture system 101. In various embodiments, the lid can operate on a hinge, or slidably, or in any other way as will occur to one of ordinary skill in the art.

The underground agriculture system 101 can include an irrigation system 310. In various embodiments, the irrigation system 310 can include the pump 306, the reservoir 307, and an extraction tube 311. In certain embodiments, the irrigation system 310 collects plant byproducts and runoff water from the growing modules 205. In at least one embodiment, the pump 306 removes the plant byproducts and runoff water from the reservoir through the extraction tube 311. In various embodiments, the pump 306 moves the runoff water and plant byproducts to one of the storage tanks 111. The runoff water and the plant byproduct collected in the storage tank 111 can be processed to extract all reusable substances. In various embodiments, the pump 306 can be placed at the base 321.

The area below the aperture 201, including the void, may be referred to as a vertical farming shaft 309. In some embodiments, the vertical farming shaft 309 can include all areas within the underground agriculture system 101 used for growing particular plants, fungi, and/or other organisms.

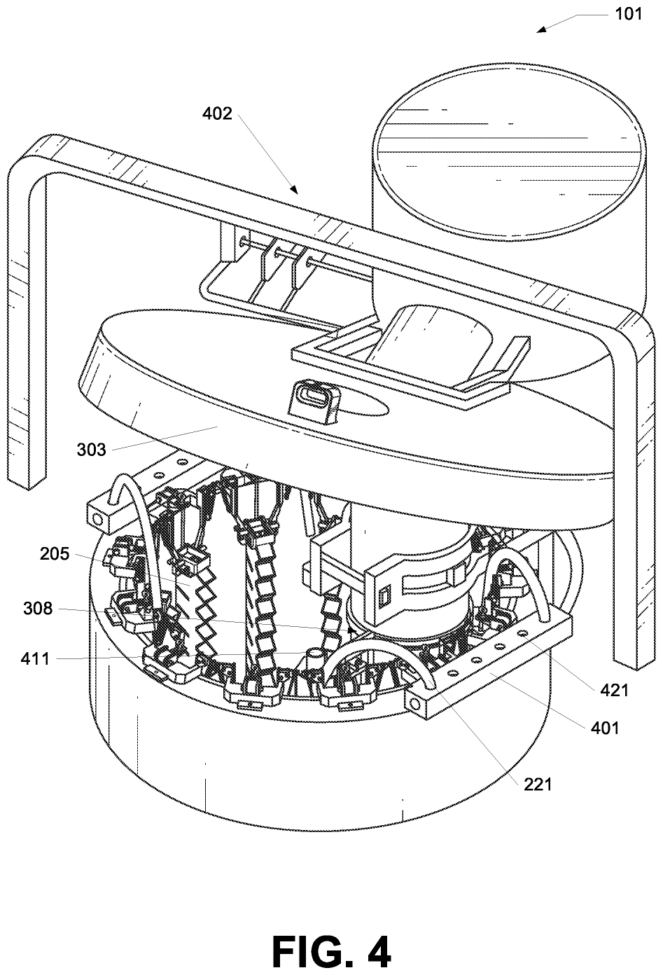

Referring now to FIG. 4, illustrated is an enhanced perspective view of the underground agriculture system 101, according to one embodiment of the present disclosure. In some embodiments, the underground agriculture system 101 includes an overhead gantry crane 402 to operatively open and close the lid 303. In various embodiments, the gantry crane may be operated through the central control unit 102. For example, the central control unit 102 may activate a closing procedure to close the lid 303. In another example, the central control unit 102 may activate an opening procedure to open the lid 303. In various embodiments, the overhead gantry crane 402 is substantially similar to the extraction system and is used to extract growing modules 205 from the underground agriculture system 101.

In various embodiments, the nutrient delivery system includes nutrient manifolds 401. The nutrient manifold 401 may facilitate distributing nutrients to individual growing modules 205. In various embodiments, the nutrient manifolds 401 may have at least one or more distribution apertures 421. The distribution apertures 421 may connect to the feeding tubes 221 to distribute nutrients to various growing modules 205. In one or more embodiments, the nutrient manifolds 401 connect to either the nutrient pump 203 (not pictured) or the nutrient tank 202 (not pictured). The nutrient manifolds 401 may equally divert nutrients into each connected feeding tube 221. Distribution apertures 421 without feeding tubes 221 may include stops (not pictured) to block the flow of nutrients.

Embodiments of the utility module 308 may include a central water duct 411. In some embodiments, the central water duct 411 replaces the extraction tube 311. For example, the central water duct 411 may be connected to the pump 306. In some embodiments, the pump 306 may move runoff water and plant byproducts from the reservoir 307 through the water duct 411 to the storage tanks 111. In various embodiments, the central water duct 411 acts as a coolant for the light fixtures attached to the utility module 308. For example, as water travels through the central water duct 411, the light fixtures attached to the utility module 308 may dissipate heat through the central water duct 411 to the water.

Referring now to FIG. 5, illustrated is an enhanced perspective view of the aperture 201 of the underground agriculture system 101, according to one embodiment of the present disclosure. In various embodiments, the aperture 201 may include an aperture edge 501. In particular embodiments, the aperture edge 501 demarcates the top surface of the underground agriculture system 101. In some embodiments, the aperture 201 can be the aperture of the casing 301. The aperture edge 501 may be substantially equal to the edge of the casing 301. In some embodiments, the aperture edge 501 and the aperture 201 are flush with the surface 105 (not pictured) of the body of land. For example, if the top of the casing 301 is flush with the surface 105 of the body of land, the aperture 201 and the aperture edge 501 may be flush with the surface 105 of the body of land. In at least one embodiment, the aperture edge 501 and the aperture 201 extrudes above the surface 105 of the body of land. For example, if the top of the casing 301 extends above the surface 105 of the body of land, the aperture 201 and the aperture edge 501 may be above the surface 105. In one or more embodiments, the aperture edge 501 and the aperture 201 may be below the surface 105 of the body of land. For example, if the top of the casing 301 is below the surface 105 of the body of land, the aperture 201 and the aperture edge 501 may be below the surface 105 of the body of land. The underground agriculture system 101 may include at least one or more mounting apparatuses 502. In at least one embodiment, the mounting apparatuses 502 facilitate suspending the growing modules 205 into the vertical farming shaft. In some embodiments, the mounting apparatuses 502 are appended to the aperture edge 501 of the aperture 201. For example, a first portion 702 (see FIG. 7) of the mounting apparatuses 502 is affixed to the aperture edge 501 of the aperture 201. Continuing this example, a second portion 703 of the mounting apparatuses 502 extends into the vertical farming shaft 309. In other embodiments, the mounting apparatuses 502 are affixed to the ground or another structure outside of the aperture edge 501 or the vertical farming shaft, and thus they will reach over and into the shaft.

In at least one embodiment, the growing modules 205 include growing cradles or cradles 503. In some embodiments, the growing cradles 503 can receive soil, a plant, fungi, a seed, any particular growable organism, or a combination thereof. In certain embodiments, the growing modules 205 are oriented to face the growing cradles 503 towards the center of the vertical farming shaft 309. In some embodiments, the cylindrical shape of the vertical farming shaft 309, the mounting apparatuses 502, and the growing modules 205 help facilitate facing the growing cradles 503 towards the center of the vertical farming shaft 309. By facing the growing cradles 503 into the center of the vertical farming shaft 309, any plant, fungi, or growable organism can receive increased exposure from the utility module 308. Increasing exposure from the utility module 308 may increase the potential for the growing module 205 to receive light, circulated air, and exposure to sensors and cameras for growth monitoring.

Referring now to FIG. 6, illustrated is a perspective view of the utility module 308, according to one embodiment of the present disclosure. In some embodiments, the utility module 308 can include the HVAC duct 305, the central water duct 411, at least one or more light fixture mounts 601, fan mounting plates 602, a frame 603, an electrical panel mounting plate 604, and extraction cables 605A-B. In particular embodiments, the utility module 308 and all of its components can extend the length of the vertical farming shaft 309. In some embodiments, the growing modules 205 and the utility module 308 can extend an equal, or unequal, distance through the vertical farming shaft 309.

In various embodiments, the frame 603 provides structural integrity to the utility module 308. In some embodiments, the HVAC duct 305 and the central water duct 411 are affixed to the frame 603. The HVAC duct 305 and the central water duct 411 may be affixed to the frame 603 using any particular affixing method. For example, affixing methods may include, but are not limited to, welding, cast molding as one entire piece, and additive printing techniques. The frame 603 may include a modular structure allowing for the removal and addition of different components. For example, the frame 603 can receive a set of sensors, camera, computing systems, tubes for substance extraction and insertion, and/or any other particular system. For example, a pH probe can be inserted into the frame 603 to measure the pH of the underground agriculture system 101. In particular embodiments, sensors can extend from the frame 603 and connect to the growing modules 205. In some embodiments, the growing modules 205 are retrofitted with their own set of sensors. In one or more embodiments, the frame 603 can receive infra-red sensors and/or any other sensor or system to perform electronic monitoring of the growth rate and health of the plants/fungi grown in the underground agriculture system 101. In various embodiments, the central control unit 102 can process and analyze data produce by sensor added throughout the agriculture environment 100. In at least one embodiment, the utility module 308 is integrated into or onto the surface of the casing 301 or a location other than the center of the vertical farming shaft 309.

The light fixture mounts 601 may extend outwardly from the central water duct 411. In some embodiments, the light fixture mounts 601 receive any particular lighting module. For example, the light fixture mounts 601 can receive a UVC light for disinfection and protecting plants (e.g., 100-280 nm wavelength), UV lights for plant growth, thermal lights for heating, any particular lighting source, or a combination thereof. Continuing this example, the central control unit 102 can activate the lighting modules at distinct instances depending on the necessities of the underground agriculture system 101.

Embodiments of the fan mounting plates 602 may receive a fan or any particular air circulating apparatus. In some embodiments, fans help distribute air throughout the vertical farming shaft 309. Depending on the plant or fungi being grown, the fans located at the fan mounting plates 602 can help distribute pollen or spores for increasing plant pollination. For example, the central control unit 102 can increase the speed of the fans during a pollination period to increase plant pollination. In another example, pollination-friendly insects can be released into the vertical farming shaft 309 through the HVAC duct 305 or the lid 303 to facilitate pollination.

An electrical panel mounting plate 604 may receive an electrical panel that communicates with fans, lighting modules, sensors, or any other electrical system dispersed throughout the utility module 308 or the agriculture environment 100. For example, the electrical panel attached to the electrical panel mounting plate 604 may communicate with the central control unit 102.

Extraction cables 305A-B may extend the length of the utility module 308 and may anchor to the distal end of the utility module 308. In various embodiments, the utility module 308 is extractable from the vertical farming shaft. For example, the HVAC duct 305 can be detached from the HVAC system 302, and the central water duct 411 can disconnect from the pump 306. Once disconnected, the extraction system 204 and/or the overhead gantry crane 402 may connect to the extraction cables 305A-B and remove the utility module 308.

Referring now to FIG. 7, illustrated is a perspective view of the mounting apparatus 502, according to one embodiment of the present disclosure. In particular embodiments, the mounting apparatus 502 can include a growing module hook 701, a first portion 702, a second portion 703, and a hook stop 704. The first portion 702 may extend on the aperture edge 501 (not pictured). The first portion 702 may receive a affixing mechanism through an appending aperture 711. The affixing mechanism (e.g., bolt, screw, rivet, nail, etc.) can extend through the appending aperture 711 and affix the mounting apparatus 502 to the surface 105, the aperture edge 501, and/or any other fixed location. The second portion 703 can extend over the aperture edge 501 and provide support for holding growing modules 205. The growing module 205 can be connected with the mounting apparatus 502. For example, the mounting apparatus can include a locking mechanism that secures the growing module 205 to the mounting apparatus during insertion of the growing modules 205, during removal of the growing modules 205, or during general use of the mounting apparatus 502.

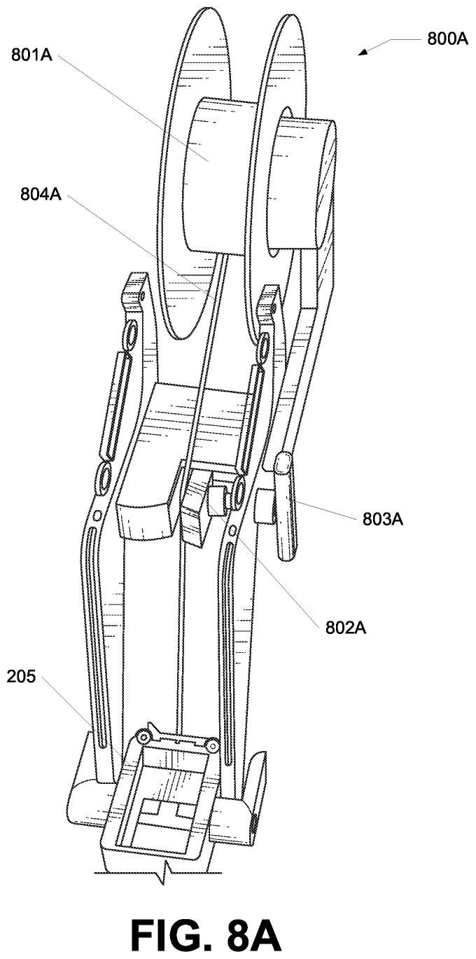

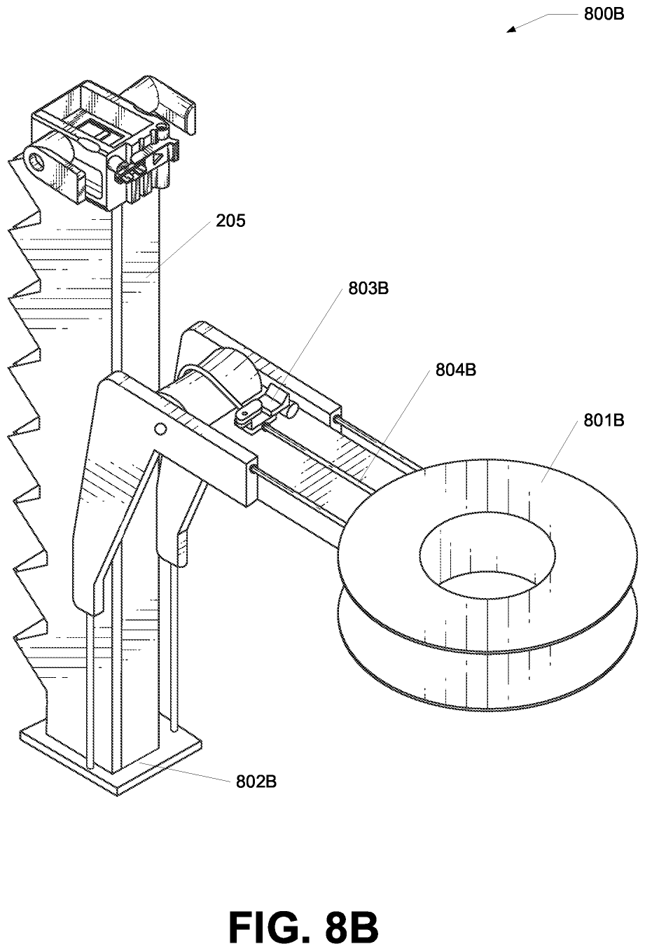

In one or more embodiments, the growing module hook 701 extends from the growing module 205 and can attach to the extraction hook 216 of the extraction module 204. The growing module hook 701 may be affixed to a growing module cable 722. The growing module cable 722 may be affixed to the base of the growing module 205, the top of the growing module 205, or any particular location to facilitate removing the growing module 205 from the vertical farming shaft 309. The mounting apparatus 502 can support the weight of the growing modules 205. For example, the hook stop 704 can support the weight of the hook 701, which is connected to the growing module 205 through the growing module cable 722. In another example, the mounting apparatus 502 can include base cables 721. The base cables 722 may be attached to a base plate (not pictured—see FIG. 8B). The base plate can extend to the lowest point of the mounting apparatus 502. The growing modules 205 can extend into the vertical farming shaft 309 and rest on the base plate or holster of the mounting apparatuses 502. On resting the growing module 205 on the base plate, the growing module hook 701 can be attached to the hook stop 704 for further support. In at least one or more embodiments, the particular distance the base cables 722 extend into the vertical farming shaft 309 can be substantially similar to the distance the growing modules 205 extend into the vertical farming shaft. The base cables can be attached to springs 723 to add additional support. In certain embodiments, the base cables are secured with a lock 731.

Referring now to FIG. 8A, illustrated is a second exemplary mounting apparatus 800A, according to one embodiment of the present disclosure. The second mounting apparatus 800A can include a wheel 801A, a locking mechanism 802A, a locking action 803A, and a growing module cable 804A. In various embodiments, the second mounting apparatus 800A can mount to the underground agriculture system 101 substantially similar to the mounting apparatus 502. In various embodiments, the wheel 801A can turn and coil the growing module cable 804A. As the growing module cable 804A is turned by the wheel 801A, the growing module 205 can be removed from the vertical farming shaft 309. In at least one embodiment, turning the locking action 803A can either activate or deactivate the locking mechanism 802A, which stops or continues the removal or insertion of the growing module 205 into the vertical farming shaft 309.

Referring now to FIG. 8B, illustrated is a perspective view of a third mounting apparatus 800B, according to one embodiment of the present disclosure. In various embodiments, the third mounting apparatus 800B can mount to the underground agriculture system 101 substantially similar to the mounting apparatus 502 and/or the second mounting apparatus 800A. In at least one embodiment, the third mounting apparatus 800B can include a wheel 801B, a base plate 802B, a locking mechanism 803B, and a growing module cable 804B. The growing module 205 can rest on the base plate 802B. The mounting apparatus 502 and the second mounting apparatus 800A can include a substantially similar base plate. In particular embodiments, the wheel 801B turns when the locking mechanism 803B is in an unlocked state. Turning the wheel 801B coils the growing module cable 804B around the wheel. As the growing module cable is coiled around the wheel 801B the base plate 802B is pulled up, simultaneously pulling up the growing module 205. In some embodiments the growing module cable 804 is connected directly to the growing module 205 and pulls the growing module 205 from the vertical farming shaft.

While various aspects have been described in the context of a preferred embodiment, additional aspects, features, and methodologies of the claimed systems will be readily discernible from the description herein, by those of ordinary skill in the art. Many embodiments and adaptations of the disclosure and claimed systems other than those herein described, as well as many variations, modifications, and equivalent arrangements and methodologies, will be apparent from or reasonably suggested by the disclosure and the foregoing description thereof, without departing from the substance or scope of the claims. Furthermore, any sequence(s) and/or temporal order of steps of various processes described and claimed herein are those considered to be the best mode contemplated for carrying out the claimed systems. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in a variety of different sequences and orders, while still falling within the scope of the claimed systems. In addition, some steps may be carried out simultaneously, contemporaneously, or in synchronization with other steps.

Aspects, features, and benefits of the claimed devices and methods for using the same will become apparent from the information disclosed in the exhibits and the other applications as incorporated by reference. Variations and modifications to the disclosed systems and methods may be affected without departing from the spirit and scope of the novel concepts of the disclosure.

It will, nevertheless, be understood that no limitation of the scope of the disclosure is intended by the information disclosed in the exhibits or the applications incorporated by reference; any alterations and further modifications of the described or illustrated embodiments, and any further applications of the principles of the disclosure as illustrated therein are contemplated as would normally occur to one skilled in the art to which the disclosure relates.

The foregoing description of the exemplary embodiments has been presented only for the purposes of illustration and description and is not intended to be exhaustive or to limit the devices and methods for using the same to the precise forms disclosed. Many modifications and variations are possible in light of the above teaching.

The embodiments were chosen and described in order to explain the principles of the devices and methods for using the same and their practical application so as to enable others skilled in the art to utilize the devices and methods for using the same and various embodiments and with various modifications as are suited to the particular use contemplated. Alternative embodiments will become apparent to those skilled in the art to which the present devices and methods for using the same pertain without departing from their spirit and scope. Accordingly, the scope of the present devices and methods for using the same is defined by the appended claims rather than the foregoing description and the exemplary embodiments described therein.

What is claimed is:

1. An underground agriculture system, comprising:
a vertical farming shaft comprising a void extending downwardly from an aperture on a surface of a body of land to a predetermined depth below the surface of the body of land;
one or more mounting apparatuses attached proximate to an edge of the aperture;
one or more retractable growing modules attached to the one or more mounting apparatuses and extending downwardly into the void of the vertical farming shaft;
a nutrient delivery system comprising a tank and one or more feeding tubes connecting the tank to the one or more retractable growing modules;
a lighting module extending downwardly into the void of the vertical farming shaft;
a heating, ventilation, and air conditioning (HVAC) system extending into the void of the vertical farming shaft; and
an irrigation system comprising a reservoir at a distal end of the vertical farming shaft and a pump operatively connected to the reservoir.

2. The underground agriculture system of claim 1, further comprising a retractable lid for covering the aperture on the surface of the body of land.

3. The underground agriculture system of claim 1, wherein the pump is configured to pump water and plant byproduct from the reservoir at the distal end of the vertical farming shaft to a location outside of the vertical farming shaft.

4. The underground agriculture system of claim 1, wherein the one or more retractable growing modules include a plurality of plant cradles for holding a plurality of plants, fungi, or a combination thereof.

5. The underground agriculture system of claim 1, further including an extraction system, comprising:
a frame extending over the aperture on the surface of the body of land;
a hoist system including an attachment means that is operatively connected to at least one of the one or more retractable growing modules and is configured to raise the growing modules out of the vertical farming shaft.

6. The underground agriculture system of claim 1, wherein the vertical farming shaft has a cross-section comprising a circular shape, a rectangular shape, a square shape, a trapezoidal shape, an oval shape, an obround shape, or a polygon shape.

7. The underground agriculture system of claim 6, wherein the circular shape of the vertical farming shaft comprises a diameter in the range of 1-60 feet.

8. The underground agriculture system of claim 1, wherein the nutrient delivery system includes a nutrient pump operatively connected to the tank and the one or more feeding tubes and is configured to move nutrients from the tank to the one or more retractable growing modules.

9. The underground agriculture system of claim 8, wherein nutrients mixed into the tank of the nutrient delivery system comprise nitrogen, phosphorus, potassium, calcium, water, or a combination thereof.

10. The underground agriculture system of claim 1, further comprising a casing mated with a circumferential surface of the vertical farming shaft.

11. The underground agriculture system of claim 10, wherein the casing is made from, steel, stainless-steel, aluminum, polypropylene, a non-corrosive environmentally-stable material, or a combination thereof.

12. The underground agriculture system of claim 1, wherein the one or more mounting apparatuses each further comprise:
a holster suspended from one or more cables at a position within the vertical farming shaft; and
a hooking mechanism.

13. The underground agriculture system of claim 12, wherein the holster receives a lowermost end of the one or more retractable growing modules and the hooking mechanism receives an extraction cable connected to the one or more retractable growing modules.

14. An underground agriculture system, comprising:
a cylindrical farming shaft defining a cylindrical void extending downwardly from a surface of a body of land to a predetermined depth below the surface of the body of land;
a casing encircling a circumference of the cylindrical farming shaft and configured to segregate the cylindrical void from the body of land;
a plurality of mounting apparatuses mounted externally to the cylindrical farming shaft and extending at least partially into the cylindrical void;
a plurality of retractable growing modules operatively connected to the plurality of mounting apparatuses and extending downwardly into the cylindrical void of the cylindrical farming shaft, wherein each retractable growing module is attached to a respective mounting apparatus and is configured to be lifted from the cylindrical void by cables pulled via the respective mounting apparatus;
a nutrient delivery system comprising a tank and a plurality of feeding tubes connecting the tank to the plurality of retractable growing modules;
a utility module extending downwardly into the cylindrical void coaxially with the cylindrical farming shaft, wherein the utility module comprises:
a lighting module configured to provide light radially outwardly from the utility module to the plurality of retractable growing modules; and
an air delivery system configured to provide heated or cooled air into the cylindrical void of the cylindrical farming shaft; and
an irrigation system comprising a reservoir at a lowermost end of the cylindrical farming shaft and a pump operatively connected to the reservoir.

15. The underground agriculture system of claim 14, wherein the pump is configured to pump water and plant byproduct from the reservoir at the lowermost end of the cylindrical farming shaft to a location outside of the cylindrical farming shaft.

16. The underground agriculture system of claim 14, wherein the plurality of retractable growing modules each include a plurality of plant cradles for holding a plurality of plants, fungi, or a combination thereof.

17. The underground agriculture system of claim 14, wherein the nutrient delivery system includes a nutrient pump operatively connected to the tank and the plurality of feeding tubes and is configured to move nutrients from the tank to the plurality of retractable growing modules.

18. The underground agriculture system of claim 14, further comprising a control unit that is configured to control the plurality of mounting apparatuses, the nutrient delivery system, the utility module, and the irrigation system.

19. The underground agriculture system of claim 14, wherein the lighting module is configured to produce light with a wavelength in the range of 100-280 nanometers to sanitize interior surfaces of the cylindrical farming shaft.

20. The underground agriculture system of claim 14, wherein the air delivery system is configured to inject a particular amount of carbon-dioxide, nitrogen, oxygen, or a combination thereof into the cylindrical farming shaft.

21. The underground agriculture system of claim 14, wherein the utility module further comprises turbulence fans, motorized drivers, and electronic components configured to operate the lighting module, air delivery system, turbulence fans, and motorized drivers.
